(19) United States
(12) Patent Application Publication
(10) Pub. No.: US 2017/0153132 A1
(43) Pub. Date: Jun. 1, 2017

(54) MEASUREMENT OF FLOW THROUGH PIPELINES

(71) Applicant: Rubicon Research Pty Ltd, Hawthorn, Victoria (AU)

(72) Inventor: David John Aughton, Hawthorn (AU)

(73) Assignee: Rubicon Research Pty Ltd, Hawthorn, Victoria (AU)

(21) Appl. No.: 15/323,710

(22) PCT Filed: Jul. 3, 2015
(86) PCT No.: PCT/AU2015/050374

§ 371 Date: Jan. 3, 2017

(30) Foreign Application Priority Data
Jul. 6, 2014 (AU) 2014902595

(51) Int. Cl. G01F 1/40; G01F 25/00; G01F 15/00; G05D 7/06; G01F 1/66; G01F 1/60

(52) U.S. Cl. CPC G01F 1/40; G01F 1/667; G01F 1/60; G01F 15/005; G05D 7/0635; G01F 25/0007

(57) ABSTRACT

A method of measuring the flow rate of fluid through a gate member attached to a pipeline. The pipeline including includes a flow meter upstream and adjacent the gate member. The flow meter provides a flow output to measure the fluid flow through the flow meter. The method includes steps of monitoring the flow output from the flow meter; monitoring the gate opening position of the gate member; determining a relationship or algorithm for the flow rate using calculations derived from system identification techniques based on data received from the monitoring of the flow output from the flow meter and data received from the monitoring of the gate opening position; and once the relationship or algorithm has been determined, using the relationship or algorithm to subsequently measure said flow rate.

### FIELD OF THE INVENTION

The present invention relates to a method of measuring the flow rate of fluid through a gate member attached to a pipeline and relates particularly, but not exclusively to a method of measuring the flow rate of water through a gate member attached to an irrigation pipeline.

### BACKGROUND OF THE INVENTION

In our International Patent Application PCT/AU2012/000907 (the entirety of which is herein incorporated), we described a flow meter assembly with various orientations of pairs of acoustic transducers for measurement of flow of water through a gate member coupled to the pipeline. The acoustic transducers formed a flow meter, which was upstream of the gate member. The pairs of acoustic transducers could be on opposing sides of the pipeline at varying heights. The pairs of acoustic transducers could be on opposing sides of the pipeline but longitudinally offset from one another along the pipeline. This option allowed a redundancy factor if an acoustic transducer failed.

The preferred embodiments used ‘ultrasonic transit time flow measurement’ techniques. Ultrasonic transit time flow meters measure the difference of the transit time of ultrasonic pulses propagating in and against the direction of flow. This time difference is a measure for the average velocity of the fluid along the path of the ultrasonic beam. By using the absolute transit times both the averaged fluid velocity and the speed of sound can be calculated. Using the two transit times ^{t}up and ^{t}down and the distance between receiving and transmitting transducers L and the inclination angle α the following equations are developed:

$$v = \frac{L}{2 sin ( α )} \frac{{}^{t} up - {}^{t} down}{{}^{t} up {}^{t} down} and c = \frac{L}{2} \frac{{}^{t} up - {}^{t} down}{{}^{t} up {}^{t} down}$$

where V is the average velocity of the fluid along the sound path and c is the speed of sound.

Problems arise when the location of the flow meter immediately upstream of the gate member causes severe distortion in the flow paths passing through the meter and therefore distort the reading of the flow meter. The flow meter on its own will not measure flows in this condition accurately. The transit time method of determining the flow is derived using physical measurements and computations based on the geometry and on the assumption of a stable and symmetrical profile being developed in the pipe at the flow meter.

### OBJECTS OF THE INVENTION

It is an object of the invention to provide a better measurement of flow where distortions in readings result from the flow meter being immediately upstream of the gate member.

A further object of the invention is to provide a more compact combination of the flow meter and gate member.

### SUMMARY OF THE INVENTION

The present invention in one embodiment provides a method of measuring the flow rate of fluid through a gate member attached to a pipeline, said pipeline including a flow meter upstream and adjacent said gate member, said flow meter providing a flow output to measure the fluid flow through said flow meter, said method including the steps of monitoring said flow output from said flow meter; monitoring the gate opening position of said gate member; determining a relationship or algorithm for said flow rate using calculations derived from system identification techniques based on data received from the monitoring of the flow output from said flow meter and data received from the monitoring of the gate opening position; and once said relationship or algorithm has been determined, using said relationship or algorithm to subsequently measure said flow rate.

Preferably said flow output from said flow meter is from a magnetic flow meter.

In another preferred embodiment said flow meter includes at least one pair of facing acoustic transducers to measure the ultrasonic transit times through said fluid, said method further including the steps of monitoring said ultrasonic transit times through said fluid, whereby said calculations derived from system identification techniques are based on data received from the monitoring of said ultrasonic transit times through said fluid and data received from the monitoring of the gate opening position. A plurality of pairs of facing acoustic transducers may be included in said flow meter. The plurality of pairs of facing acoustic transducers can be oriented to be on opposing sides of the pipeline at varying heights and/or be on opposing sides of the pipeline but longitudinally offset from one another along the pipeline and/or combinations thereof.

In a practical embodiment the pressure head upstream of said flow meter is monitored and calculations derived from system identification techniques includes data received from the monitoring of the pressure head upstream of said flow meter. The pressure head downstream of said gate member may be monitored and calculations derived from system identification techniques includes data received from the monitoring of the pressure head upstream of said flow meter.

It is preferred that the data from said gate opening position is derived from the digital output of a shaft encoder coupled to said gate member.

In another aspect of the invention there may be provided in combination, a flow meter, a movable gate member and conduit, said conduit having said movable gate member at one end of said conduit to, in use, control flow of fluid therethrough, said flow meter integrated with said conduit and including at least one pair of facing acoustic transducers to measure the ultrasonic transit times through said fluid, a computer controller or software control to monitor said at least one pair of facing acoustic transducers and control operation of said movable gate member, said computer controller or software control adapted to monitor said ultrasonic transit times through said fluid and to monitor the gate opening position of said gate member and determine a relationship or algorithm for flow rate using calculations derived from system identification techniques based on data received from the monitoring of said ultrasonic transit times through said fluid and data received from the monitoring of the gate opening position and once said relationship or algorithm has been determined, using said relationship or algorithm to subsequently measure said flow rate.

Preferably a pressure sensor is provided within said conduit wherein the pressure head upstream of said flow meter is monitored and calculations derived from system identification techniques includes data received from the monitoring of the pressure head upstream of said flow meter. The flow output from said flow meter may be from a magnetic flow meter. The pressure head downstream of said gate member may be monitored and calculations derived from system identification techniques includes data received from the monitoring of the pressure head upstream of said flow meter. A plurality of pairs of facing acoustic transducers may be included in said flow meter. The plurality of pairs of facing acoustic transducers can be oriented to be on opposing sides of the pipeline at varying heights and/or be on opposing sides of the pipeline but longitudinally offset from one another along the pipeline and/or combinations thereof. Preferably the data from said gate opening position is derived from the digital output of a shaft encoder coupled to said gate member.

In a further example of the invention there may be provided in combination, a flow meter, a movable gate member and conduit, said conduit having said movable gate member at one end of said conduit to, in use, control flow of fluid therethrough, said flow meter integrated with said conduit and providing a flow output to measure the fluid flow through said flow meter, a computer controller or software control to monitor said flow output and control operation of said movable gate member, said computer controller or software control adapted to monitor said flow output from said flow meter and to monitor the gate opening position of said gate member and determine a relationship or algorithm for said flow rate using calculations derived from system identification techniques based on data received from the monitoring of said flow output from said flow meter and data received from the monitoring of the gate opening position and once said relationship or algorithm has been determined, using said relationship or algorithm to subsequently measure said flow rate.

A further aspect of the invention may include a gate member in the form of a knife gate valve including a knife slidably located within a housing, said housing having opposing apertures which fluid, in use, passes therethrough dependent on the position of said knife in said housing, said knife adapted to be raised and lowered by at least one threaded journal on one side of said knife co-operating with a rotatable threaded member on said housing, and a motor coupled directly, or indirectly, to said rotatable threaded member.

### BRIEF DESCRIPTION OF THE DRAWINGS

The structure and functional features of preferred embodiments of the present invention will become more apparent from the following detailed description when taken in conjunction with the accompanying drawings, in which: —

FIG. 1 is a cross-sectional view of a gate member positioned in a pipeline and showing the flow of fluid therethrough;

FIG. 2 is a similar view to that of FIG. 1 showing a flow meter also positioned in the pipeline according to the prior art;

FIG. 3 is a similar view to that of FIG. 2 but showing the operation of a first embodiment of the invention;

FIG. 4 is a cross-section view through the pipeline shown in FIG. 3;

FIG. 5 is a similar view to that of FIG. 3 but showing the operation of a second embodiment of the invention;

FIG. 6 is a similar view to that of FIG. 5 but showing the operation of a third embodiment of the invention;

FIG. 7 is a front perspective view of a first embodiment of a gate member in accordance with the invention that controls flow of fluid through the pipeline with the cowling removed;

FIG. 8 is a rear perspective view of the gate member shown in FIG. 7 with a protective cowling;

FIG. 9 is the same view as FIG. 7 with the cowling;

FIG. 10 is a front view of FIG. 7;

FIG. 11 is a cross-sectional view along and in the direction of arrows 11-11 shown in FIG. 10;

FIG. 12 is a front perspective view of a second embodiment of a gate member in accordance with the invention that controls flow of fluid through the pipeline with the cowling removed;

FIG. 13 is a rear perspective view of the gate member shown in FIG. 12 with a protective cowling;

FIG. 14 is the same view as FIG. 12 with the cowling;

FIG. 15 is a front view of FIG. 12; and

FIG. 16 is a cross-sectional view along and in the direction of arrows 15-15 shown in FIG. 10.

### DESCRIPTION OF THE PREFERRED EMBODIMENTS

In order to avoid duplication of description, identical reference numerals will be shown, where applicable, throughout the illustrated embodiments to indicate similar integers.

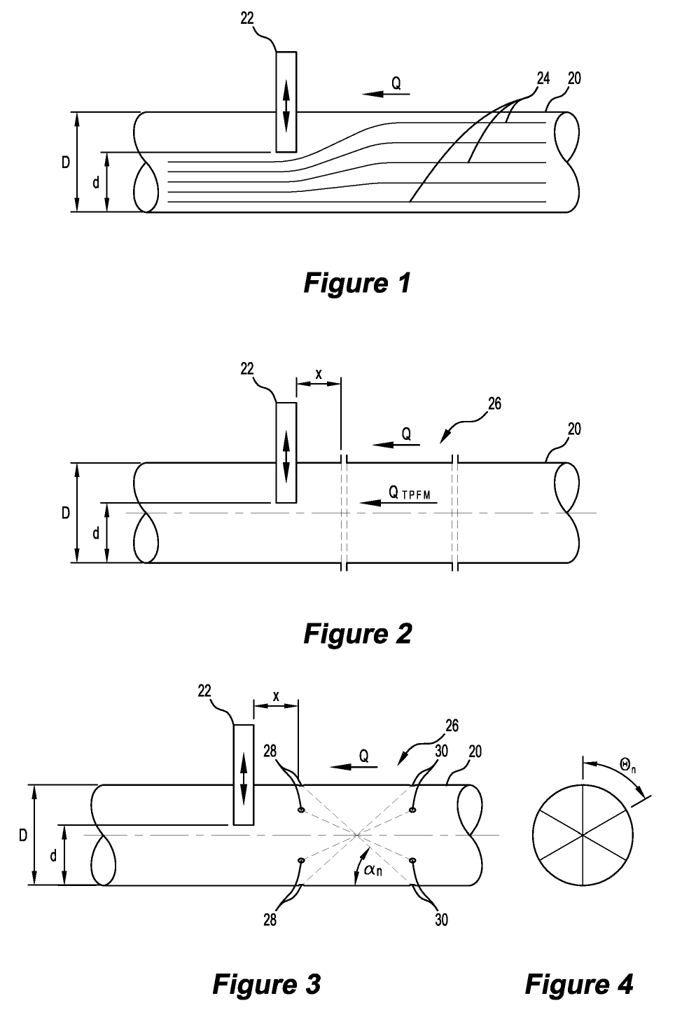

FIG. 1 shows the flow of liquid through a pipeline 20. A gate member 22, typically a gate knife valve, is movable upwardly and downwardly to open and close flow of liquid through pipeline 20. Flow lines 24 show the smooth movement of liquid through pipeline 20 and how turbulence can occur. Flow lines 24 do not give an accurate rendition of the turbulence, as the swirling nature of the flow of liquid near the gate member 22 is not shown. Measurement of flow adjacent gate member 22 is difficult and prone to error in view of the turbulence.

FIG. 2 shows a similar view to that of FIG. 1 but includes a flow meter 26 inserted into pipeline 20. The prior art has used magnetic flow meters where flow is separated into layers and flow rate determined. Unfortunately, the flow rate Q_{TPFM}, as measured by the flow meter, does not accurately reflect the actual flow rate Q. The distance x of the flow meter 26 from gate member 22, the diameter D of pipeline 20, the turbulence and the gate opening d contribute to the inaccuracy of the difference between actual flow rate Q and measured flow rate Q_{TPFM}.

The present invention provides better accuracy in the measurement of the actual flow rate Q by using system identification techniques instead of relying on the data supplied by the flow meter 26. System identification is a known technique where a dynamical mathematical model provides a mathematical description of the dynamic behaviour of a system or process in the time domain. A typical approach is therefore to start from measurements of the behaviour of the system and the external influences (inputs to the system) and try to determine a mathematical relation between them without going into the details of what is actually happening inside the system. This approach is called system identification. System identification techniques can utilize both input and output data. Typically an input-output technique would be more accurate. The quality of system identification depends on the quality of the inputs, which are under the control of the systems engineer. Therefore, systems engineers have long used the principles of the design of experiments. In recent decades, engineers have increasingly used the theory of optimal experimental design to specify inputs that yield maximally precise estimators. Accordingly, system identification techniques are used to generate an algorithm or relationship based on the experimental measurements. The development of the algorithm will incorporate the output data Q_{TPFM} from the flow meter 26 and the gate position d in the calibration of the flow reading based on the level of distortion that will occur due to the varying position of the gate member 22. The development of the algorithm may include the diameter D of pipeline 20 and the distance x of the flow meter 26 from gate member 22. The algorithm can be used to provide the flow rate Q for the installation based on the continually monitored output data Q_{TPFM} from the flow meter 26 and the gate position d. The flow rate can be represented as Q=f (Q_{TPFM}, d, D, x).

FIGS. 3 and 4 is the embodiment discussed in relation to FIG. 2 but the flow meter uses acoustic transducers for better accuracy and will work on non-conductive fluids. Pairs of acoustic transducers 28, 30 face each other and send ultrasonic pulses to each other. The number n, of pairs of acoustic transducers 28, 30 can vary from 1 to any practical limit. The illustrated embodiment includes three (3) pairs of acoustic transducers 28, 30 with a radial angle Θₙ therebetween and at an inclination angle αn. The acoustic paths (pathₙ₌₁, pathₙ₌₂ . . . path_{n=N}), where N=the number of acoustic paths i.e. N=3 in this embodiment, for the respective facing pairs of acoustic transducer 28, 30 can vary and be opposite one another, if inclination angle αₙ is 90°.

Using system identification techniques previously discussed, a relationship or algorithm will be developed using the gate position d and the individual transit time measurements t_{up n} and t_{down n} for the individual acoustic ‘transit time’ paths path n=1 to n=N to determine accurate and repeatable flow measurements Q. It is anticipated the individual acoustic paths of the flow meter will give an improved algorithm because the acoustic paths will transect the distorted flow paths at a range of orientations and therefore give a better weighting of the relative input associated with each acoustic path. This embodiment, however, will use the raw t_{up n} and t_{down n} measurements for each path in order to develop an empirical algorithm based on the position d of the gate member 22.

The other inputs that can be incorporated into the derivation of the algorithm are the radial angles Θ_{1 to n}, inclination angles α_{1 to n}, the distance x of the flow meter 26 from gate member 22 and the diameter D of pipeline 20. The flow rate Q can be represented as Q=f[(t_{up n}, t_{down n}, Θₙ, αₙ)_{n=1 . . . N}, x, d, D].

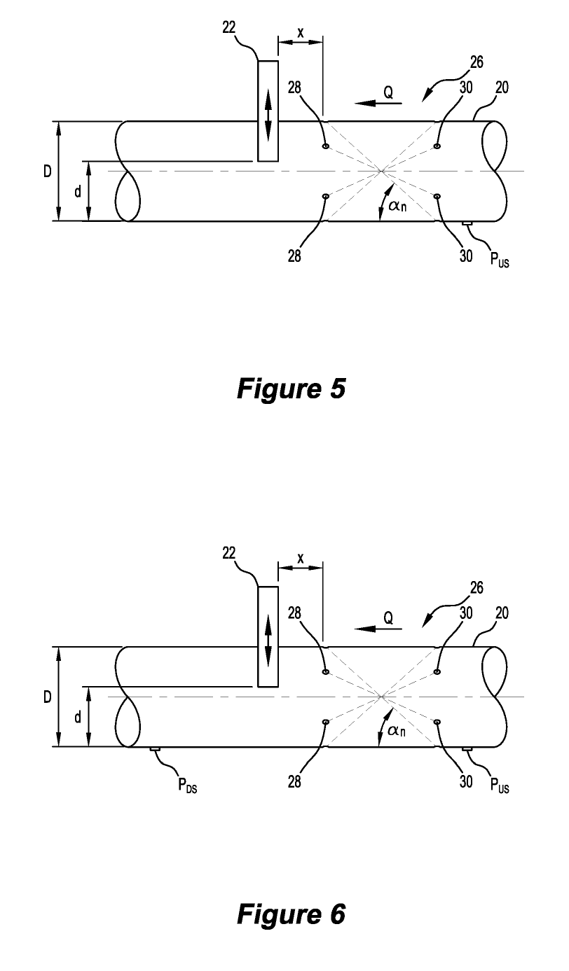

FIG. 5 is the same embodiment as FIGS. 3 and 4 with the inclusion of an upstream pressure sensor P_{US}. The output from pressure sensor P_{US} can also be incorporated into the derivation of the algorithm using system identification techniques. The flow rate Q can be represented as Q=f[(t_{up n}, t_{down n}, Θₙ, —ₙ)_{n=1 . . . N}, x, d, D, P_{US}].

FIG. 6 is the same embodiment as FIG. 5 with the inclusion of a downstream pressure sensor P_{DS}. The output from pressure sensor P_{DS} can also be incorporated into the derivation of the algorithm using system identification techniques. Although FIG. 6 shows the use of both pressure sensors P_{US} and P_{DS}, it is evident that sensor P_{DS} could be used without pressure sensor P_{US}. The flow rate Q can be represented as Q=f[(t_{up n}, t_{down n}, Θₙ, αₙ)_{n=1 . . . N}, x, d, D P_{DS}, P_{US}].

Once the relationship or algorithm has been determined by experimentation in the embodiments of FIGS. 2 to 6, the relationship or algorithm can be incorporated in an electronic, software or computer control for flow meter 26. The electronic, software or computer control will then monitor the flow meter and accurately measure flow rate therethrough.

The combination of the flow meter 26, the gate member 22 and a small section of pipeline 20 will provide a compact device that can be readily coupled to existing pipelines as a flow controller. This has many advantages for pipeline applications as these individual products are typically installed at separate segments of a pipeline and therefore usually requiring separate (and costly) joins (e.g. flanges, couplings). In addition, buried pipelines can require separate access pits to each individual element.

This combination can also be used in the pipeline system described in our International Patent Application PCT/AU2013/001368, the entirety of which is herein incorporated. The advantage of this new combination is that it can be deployed as part of an in-line (or continuous) pipeline connection, or as pipe end of an outlet valve and meter application in that pipeline system. The combination can also be incorporated into the demand management system model described in our International Patent Application PCT/AU2012/000907 and Australian Patent Application No. 2013903383, the entirety of both applications being herein incorporated. The downstream head (pressure) conditions at each valve can be incorporated as a variable input to the pipeline model that is used to predict the behaviour of the pipeline used by the demand management system. The downstream head (pressure) conditions at each valve can be used as an additional input to the ‘rating’ of the valve, which is used with the bulk adjustment of the valve as part of the control strategy (feed forward control). The rating will be a relationship (formula) for flow through the valve/meter based on the valve position, upstream head (pressure) and downstream head (pressure).

The combination of the flow meter 26, the gate member 22, both or one pressure sensors P_{US} and P_{DS} and a small section of pipeline 20 will provide a compact device which can function as a standard ‘pressure regulator’. The signals from the pressure sensor P_{US} or pressure sensors P_{US} and P_{DS} can be input to a controller in a computer to adjust the valve to achieve the required pressure (usually downstream of the device).

In some situations it is difficult to achieve an accurate or reliable pressure reading immediately downstream of a device. An alternate approach will be to develop an algorithm, using system identification techniques, that derives the downstream pressure, P_{Ds} based on:

1. The valve gate opening or position, d

2. The flow through the pipe, Q

3. The upstream pressure, P_{US}

Therefore,

P_{DS}=f(P_{US},Q,d)

A further embodiment of the combined elements in this device will be to produce the functionality of a ‘Check Valve’ or ‘Non-return Valve’. Using the transit time measurements it is possible to not only measure the flow but also detect the direction of the flow. Using an appropriate computer controller or software control it is possible to shut the valve when the direction of the flow changes from that which is permissible. In addition, the device can provide check valve functionality that responds to a measured ‘checking valve pressure’.

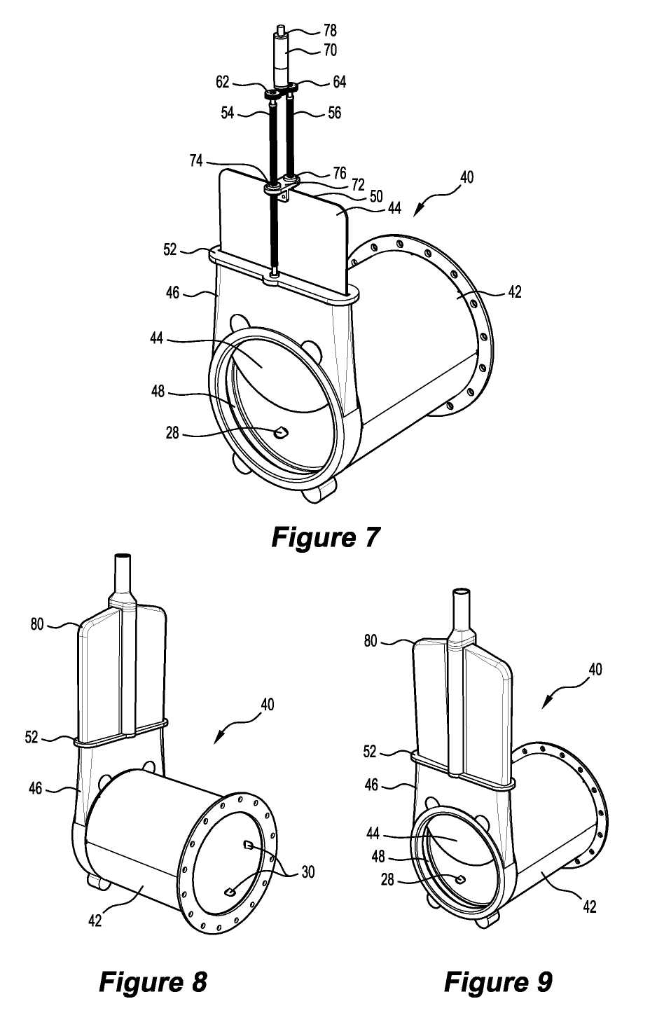

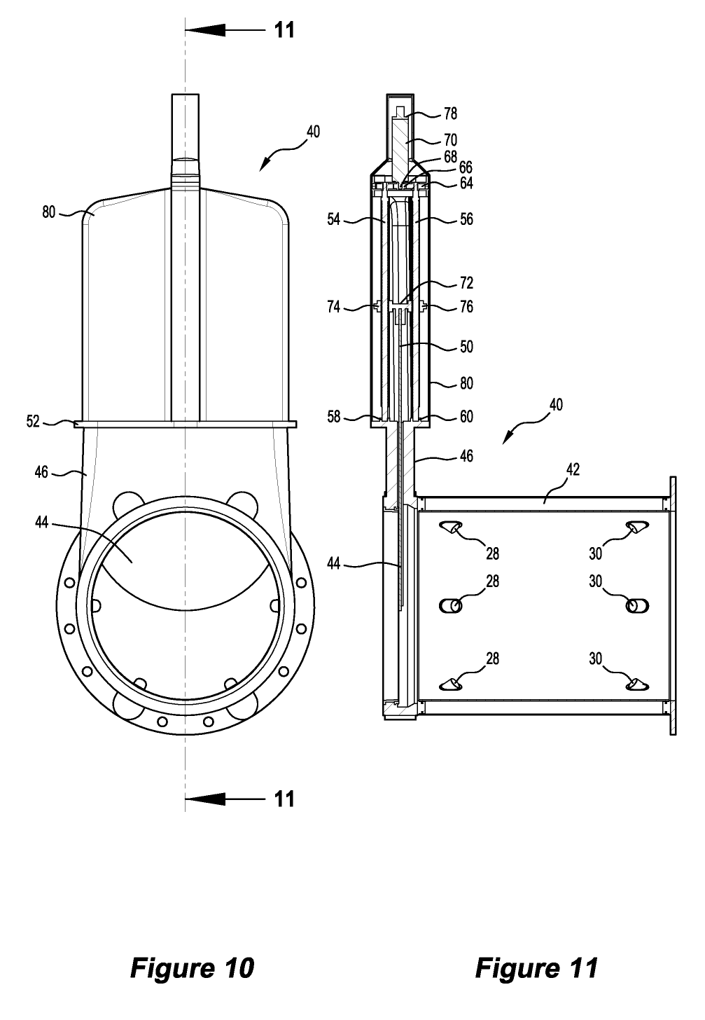

FIGS. 7 to 11 disclose a first embodiment of a gate member 40 that can be used with the embodiments shown in FIGS. 2 to 6. The gate member 40 is not limited to that purpose as it can be readily utilized in other environments. Gate member 40 is in the form of a knife-gate valve with an integrated pipe section 42 at one end. A knife-gate valve is a valve that controls flow by lowering a metal wall (the knife) 44 down across the flow path. A valve housing 46 has knife 44 slidably movable within internal guide slot 48. Seals (not shown) are located in internal guide slot 48 to prevent leakage across gate member 40. The end of knife 44 in this embodiment is arcuate but it can also have a straight cut. Typically, the end 50 of knife 44 would be connected to an actuator to pull the knife 44 upwardly. The use of an actuator increases the height of the gate member 40.

This embodiment has a support flange 52 at one end of valve housing 46. On either side of the top end of knife 44 are a pair of screw-threaded shafts 54, 56 rotatably received in journals 58, 60 on support flange 52. At the other end of screw-threaded shafts 54, 56 are a pair of gears 62, 64 forming a planetary gear drive with gear 66 at the end of drive shaft 68 of motor 70. In order to raise knife 44 a bracket 72 is secured to the end of knife 44. Bracket 72 has a pair of threaded journals 74, 76 to engage with respective screw-threaded shafts 54, 56. A shaft encoder 78 is coupled to motor 70 to provide control and feedback of the opening position of knife 44. A protective cowling 80 is fitted to support flange 52 to cover motor 70 and screw-threaded shafts 54, 56 to provide a waterproof and dust free operational environment.

In use, the shaft encoder 78 will provide signals to operate motor 70 and raise/lower knife 44. The captive nature of threaded journals 74, 76 on bracket 72 will cause the knife 44 to move as screw-threaded shafts 54, 56 rotate. Pipe section 42 includes the acoustic transducers 28, 30 as described with respect to FIGS. 2 to 6. The gate member 40 can be fitted in line in a pipeline or fitted to an end of a pipeline.

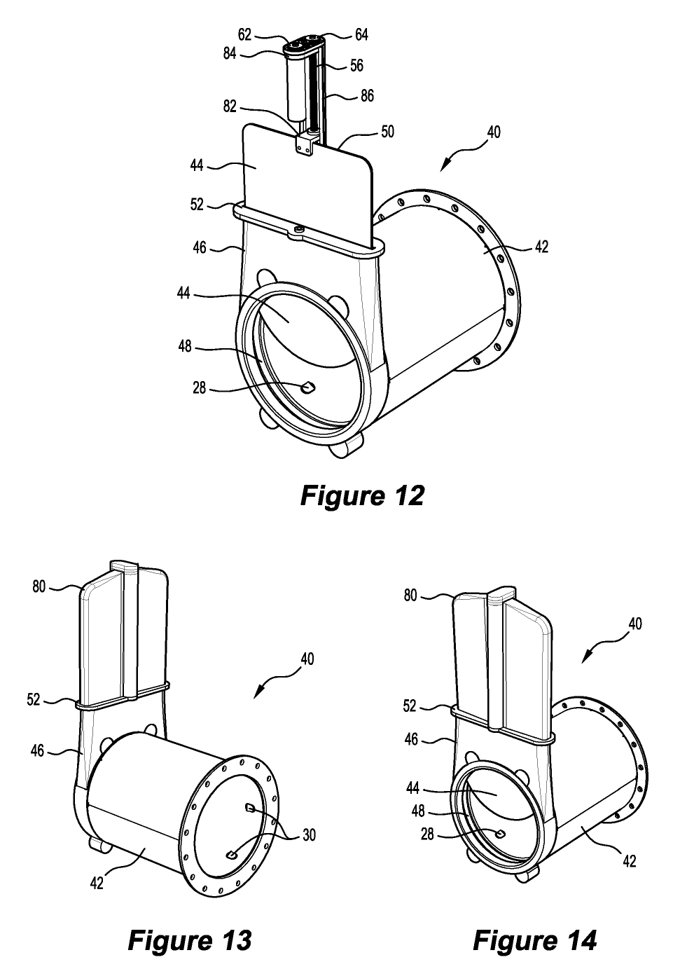

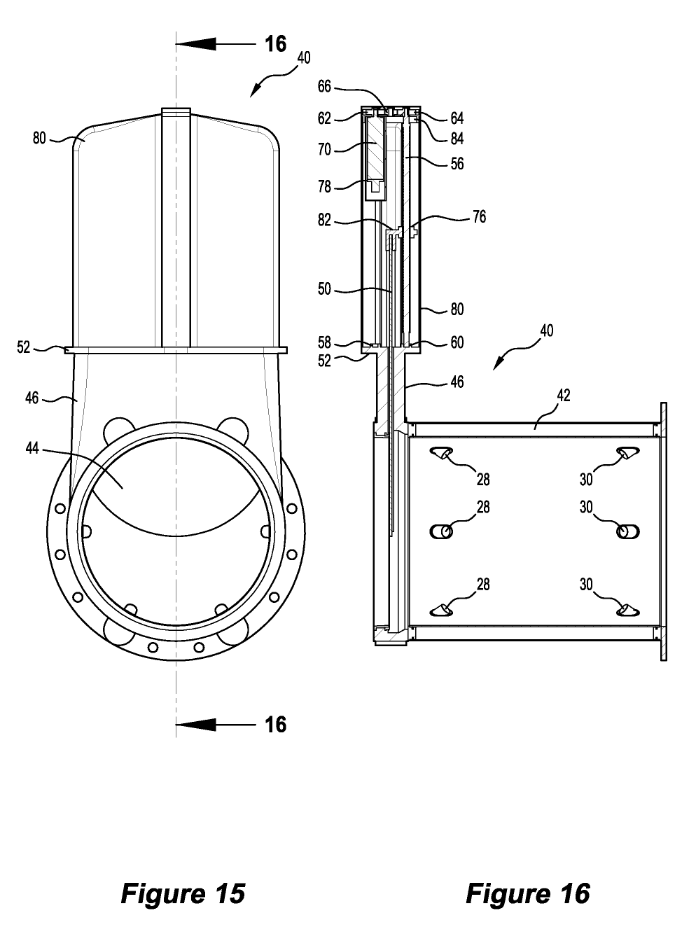

FIGS. 12 to 16 provide a second embodiment of a gate member 40 which is similar to the embodiment shown in FIGS. 7 to 11. This embodiment provides a more compact unit as screw-threaded shaft 54 is replaced by motor 70 to reduce the height of the gate member 40. Bracket 82 is secured to the end of knife 44. Bracket 82 has threaded journal 76 to engage with screw-threaded shaft 56. A gear tray 84 is attached to knife 44 by a support 86. Gear tray 84 supports gears 62, 64, 66 to form a planetary drive. As motor 70 has shifted and inverted from the embodiment of FIGS. 7 to 11 gear 66 is now an idling gear to provide motion from gear 62 attached to motor 70 to screw-threaded shaft 56.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

### APPENDIX

### Legend for FIGS. 2 to 6

Q—flow
D—pipe internal diameter
d—valve opening
Q_{TPFM}—flow reading of third party flow meter
n—acoustic path number
N—number of acoustic paths
t_{up 1}, t_{up 2}, t_{up 3}, . . . , t_{up n}—transit time for ultrasonic path n, propagating against the direction of flow Q
t_{down 1}, t_{down 2}, t_{down 3}, . . . , t_{down n}—transit time for ultrasonic path n, propagating with the direction of flow Q
αₙ—angle of inclination of acoustic path n relative to pipe axis
θₙ—radial angle of the diameter chord representing acoustic path n
x—distance between gate and flow meter
P_{DS}—pressure head from downstream pressure sensor
P_{US}—pressure head from upstream pressure sensor

1. A method of measuring a fluid flow rate of fluid through a gate member attached to a pipeline, said pipeline including a flow meter upstream and adjacent said gate member, said flow meter providing a flow output to measure a fluid flow through said flow meter, said method including the steps of monitoring said flow output from said flow meter; monitoring a gate opening position of said gate member; determining a relationship or algorithm for said fluid flow rate using calculations derived from system identification techniques based on data received from the monitoring of the flow output from said flow meter and data received from the monitoring of the gate opening position; and once said relationship or algorithm has been determined, using said relationship or algorithm to subsequently measure said fluid flow rate.

2. The method of claim 1, wherein said flow output from said flow meter is from a magnetic flow meter.

3. The method of claim 1, wherein said flow meter includes at least one pair of facing acoustic transducers to measure ultrasonic transit times through said fluid, said method further including the steps of monitoring said ultrasonic transit times through said fluid, whereby said calculations derived from the system identification techniques are based on data received from the monitoring of said ultrasonic transit times through said fluid and data received from the monitoring of the gate opening position.

4. The method of claim 1, wherein a pressure head upstream of said flow meter is monitored and calculations derived from the system identification techniques include data received from the monitoring of the pressure head upstream of said flow meter.

5. The method of claim 1, wherein a pressure head downstream of said gate member is monitored and calculations derived from the system identification techniques include data received from the monitoring of the pressure head downstream of said gate member.

6. The method of claim 3, wherein a plurality of pairs of facing acoustic transducers are included in said flow meter.

7. The method of claim 6, wherein said plurality of pairs of facing acoustic transducers can be oriented to be on opposing sides of the pipeline at varying heights and/or be on opposing sides of the pipeline but longitudinally offset from one another along the pipeline and/or combinations thereof.

8. The method of claim 1, wherein
the data from said gate opening position is derived from digital output of a shaft encoder coupled to said gate member.

9. A system comprising:
a flow meter, a movable gate member and a conduit, said conduit having said movable gate member at one end of said conduit to, in use, control flow of fluid therethrough, said flow meter integrated with said conduit and including at least one pair of facing acoustic transducers to measure ultrasonic transit times through said fluid; and
a computer controller or software control to monitor said at least one pair of facing acoustic transducers and control operation of said movable gate member, said computer controller or software control adapted to monitor said ultrasonic transit times through said fluid, monitor a gate opening position of said movable gate member, determine a relationship or algorithm for flow rate using calculations derived from system identification techniques based on data received from the monitoring of said ultrasonic transit times through said fluid and data received from the monitoring of the gate opening position, and once said relationship or algorithm has been determined, use said relationship or algorithm to subsequently measure said flow rate.

10. The system of claim 9, further including a pressure sensor within said conduit wherein a pressure head upstream of said flow meter is monitored and calculations derived from the system identification techniques include data received from the monitoring of the pressure head upstream of said flow meter.

11. The system of claim 9, wherein said flow output from said flow meter is from a magnetic flow meter.

12. The system of claim 9, wherein a pressure head downstream of said movable gate member is monitored and calculations derived from the system identification techniques include data received from the monitoring of the pressure head downstream of said moveable gate member.

13. The system of claim 12, wherein a plurality of pairs of facing acoustic transducers are included in said flow meter.

14. The system of claim 13, wherein said plurality of pairs of facing acoustic transducers can be oriented to be on opposing sides of the conduit at varying heights and/or be on opposing sides of the conduit but longitudinally offset from one another along the conduit and/or combinations thereof.

15. The system of claim 9, wherein the data from said gate opening position is derived from digital output of a shaft encoder coupled to said movable gate member.

16. A system comprising:
a flow meter, a movable gate member and a conduit, said conduit having said movable gate member at one end of said conduit to, in use, control flow of fluid therethrough, said flow meter integrated with said conduit and providing a flow output to measure fluid flow through said flow meter; and
a computer controller or software control to monitor said flow output and control operation of said movable gate member, said computer controller or software control adapted to monitor said flow output from said flow meter, monitor a gate opening position of said movable gate member, determine a relationship or algorithm for flow rate using calculations derived from system identification techniques based on data received from the monitoring of said flow output from said flow meter and data received from the monitoring of the gate opening position and once said relationship or algorithm has been determined, use said relationship or algorithm to subsequently measure said flow rate.

17. A gate member in the form of a knife gate valve including a knife slidably located within a housing, said housing having opposing apertures which fluid, in use, passes therethrough dependent on a position of said knife in said housing, said knife adapted to be raised and lowered by at least one threaded journal on one side of said knife co-operating with a rotatable threaded member on said housing, and a motor coupled directly, or indirectly, to said rotatable threaded member.

18. The system of claim 9, wherein said movable gate member is in the form of a knife gate valve including a knife slidably located within a housing, said housing having opposing apertures which fluid, in use, passes therethrough dependent on a position of said knife in said housing, said knife adapted to be raised and lowered by at least one threaded journal on one side of said knife co-operating with a rotatable threaded member on said housing, and a motor coupled directly, or indirectly, to said rotatable threaded member.
